(19) United States
(12) Patent Application Publication
(10) Pub. No.: US 2015/0074123 A1
(43) Pub. Date: Mar. 12, 2015

(54) VIDEO REMIXING SYSTEM

(71) Applicant: Nokia Corporation, Espoo (FI)

(72) Inventors: Sujeet Shyamsundar MATE, Tampere (FI); Igor Danilo Diego CURCIO, Tampere (FI)

(21) Appl. No.: 14/444,129

(22) Filed: Jul. 28, 2014

(30) Foreign Application Priority Data
Aug. 30, 2013 (GB) 1315428.1

(51) Int. Cl. G06F 17/30

(52) U.S. Cl. CPC G06F 17/30648; G06F 17/30722
USPC 707/749

(57) ABSTRACT

A method and an apparatus for selecting content for a media remix, comprising: obtaining information about a base media content to be used as a basis for the media remix in a media remix service; retrieving one or more supplementary media content from one or more network domains or multimedia content databases on the basis of said information, said supplementary media content being at least partly similar and/or relevant to the base media content; and generating a media remix on the basis of said base media content and said one or more supplementary media content.

### BACKGROUND

Multimedia capturing capabilities have become common features in portable devices. Thus, many people tend to record or capture an event, such as a music concert, a sport event or a private event such as a birthday or a wedding, they are attending. During many occasions, there are multiple attendants capturing content from an event, whereby variations in capturing location, view, equipment, etc. result in a plurality of captured versions of the event with a high amount of variety in both the quality and the content of the captured media.

Media remixing is an application where multiple media recordings are combined in order to obtain a media mix that contains some segments selected from the plurality of media recordings. Video remixing, as such, is one of the basic manual video editing applications, for which various software products and services are already available. Furthermore, there exist automatic video remixing or editing systems, which use multiple instances of user-generated or professional recordings to automatically generate a remix that combines content from the available source content.

A problem with creating the media remix relates to finding the relevant source media content. The user requesting the media remix service to create the desired media remix version must typically first search the relevant media content from a plurality of sources, such as social media portals, and then manually preview the plurality of seemingly relevant media content to verify that they are relevant for the desired media remix version. This obviously means laborious effort for the user to search and preview the content from the plurality of suggested media content items. The more number of source media items the user wants to find, the more is the effort.

### SUMMARY

Now there has been invented an improved method and technical equipment implementing the method for alleviating the above problems. Various aspects of the invention include a method, an apparatus, and a computer program, which are characterized by what is stated in the independent claims. Various embodiments of the invention are disclosed in the dependent claims.

According to a first aspect, there is provided a method for selecting content for a media remix, the method comprising: obtaining information about a base media content to be used as a basis for the media remix in a media remix service; retrieving one or more supplementary media content from one or more network domains or multimedia content databases on the basis of said information, said supplementary media content being at least partly similar and/or relevant to the base media content; and generating a media remix on the basis of said base media content and said one or more supplementary media content.

According to an embodiment, the method further comprises verifying that said base media content and said one or more supplementary media content are sufficiently similar and/or relevant according to at least one predetermined parameter; and in response to retrieving a predetermined number of sufficiently similar and/or relevant supplementary media content, generating the media remix on the basis of said base media content and said one or more supplementary media content.

According to an embodiment, the method further comprises searching information about said one or more supplementary media content from said one or more network domains or multimedia content databases on the basis of said information about the base media content; arranging the one or more supplementary media content in a priority order on the basis of metadata of said base media content; and retrieving said one or more supplementary media content from said one or more network domains or multimedia content databases in said priority order.

According to an embodiment, the at least one parameter for verifying sufficient similarity and/or relevance indicates at least one of the following:
the base media content and the supplementary media content have been captured from the same audio scene;
the base media content and the supplementary media content use the same audio track;
the base media content and the supplementary media content include a common object of interest;
the base media content and the supplementary media content are corresponding to the same event;
the base media content and the supplementary media content complement semantic information;
the base media content and the supplementary media content have at least partly similar video content or similar video content properties in at least one view;
the base media content and the supplementary media content have been captured within a predetermined time interval;
the base media content and the supplementary media content have a predetermined set of connections within a social media portal.

According to an embodiment, the method further comprises signaling said information about the base media content to the media remix service, the information comprising one or more of the following: a URI of the base media content, metadata about the base media content, a media file comprising the base media content.

According to an embodiment, the method further comprises determining said predetermined number of sufficiently similar and/or relevant supplementary media content as a threshold for a completeness parameter, wherein said completeness parameter indicates a status of available supplementary media content.

According to an embodiment, the completeness parameter is derived using one or more of the following parameters:
the number of supplementary media content verified to match the base media content;
the number of retrieved supplementary media content verified not to match the base media content;
one or more user-defined parameters for the remix;
media information, such as duration, quality, semantic characteristics;
content variety information, such as source of content, difference in content based on dominant color, number of faces, view angle.

According to an embodiment, the completeness parameter has a value as a number which is derived using one or more of said parameters.

According to an embodiment, the completeness parameter has a value in the range of 0 to 1, where the value of 1 for the completeness parameter indicates that all the necessary content is available, and the value of 0 indicates that no content is available; and the completeness parameter value of less than 1 is used as a threshold for starting to generate the media remix. The embodiment is not limited to the range of 0 to 1, but the range can be of any numbers so that the completeness parameter has a value in that range.

A second aspect of the invention relates to an apparatus comprising at least one processor, memory including computer program code, the memory and the computer program code configured to, with the at least one processor, cause the apparatus to at least: providing information about a base media content to be used as a basis for the media remix to a media remix service; retrieving one or more supplementary media content from one or more network domains or multimedia content databases on the basis of said information, said supplementary media content being at least partly similar and/or relevant to the base media content; and generating a media remix on the basis of said base media content and said one or more supplementary media content.

A third aspect of the invention relates to a computer program embodied on a non-transitory computer readable medium, the computer program comprising instructions causing, when executed on at least one processor, at least one apparatus to: providing information about a base media content to be used as a basis for the media remix to a media remix service; retrieving one or more supplementary media content from one or more network domains or multimedia content databases on the basis of said information, said supplementary media content being at least partly similar and/or relevant to the base media content; and generating a media remix on the basis of said base media content and said one or more supplementary media content.

### LIST OF DRAWINGS

In the following, various embodiments of the invention will be described in more detail with reference to the appended drawings, in which

FIGS. 1a and 1b show a system and devices suitable to be used in an automatic media remixing service according to an embodiment;

FIG. 2 shows an exemplified service architecture for creating a media remix;

FIG. 3 shows a flow chart of a method for selecting content for a media remix according to an embodiment;

FIG. 4 shows an overview of the media remix system according to an embodiment;

FIGS. 5a, 5b show an example of the user interface operation of a client application according to an embodiment;

FIG. 6 a signaling chart of an exemplary operation of the multimedia content remix service according to an embodiment;

FIGS. 7a, 7b, 7c show an example of the user interface operation of a client application according to an embodiment; and

FIG. 8 a signaling chart of an exemplary operation of the multimedia content remix service according to an embodiment.

### DESCRIPTION OF EMBODIMENTS

As is generally known, many contemporary portable devices, such as mobile phones, cameras, tablets, are provided with high quality cameras, which enable to capture high quality video files and still images. In addition to the above capabilities, such handheld electronic devices are nowadays equipped with multiple sensors that can assist different applications and services in contextualizing how the devices are used. Sensor (context) data and streams of such data can be recorded together with the video or image or other modality of recording (e.g., speech).

Usually, at events attended by a lot of people, such as live concerts, sport games, political gatherings, and other social events, there are many who record still images and videos using their portable devices, thus creating user generated content (UGC). A significant amount of this UGC will be uploaded to social media portals (SMP), such as Facebook, YouTube, Flickr®, and Picasa™, etc. These SMPs have become de facto storages of the generated social media content. The uploaded UGC recordings of the attendants from such events, possibly together with various sensor information, provide a suitable framework for the present invention and its embodiments.

The media content to be used in media remixing services may comprise at least video content including 3D video content, still images (i.e., pictures), and audio content including multi-channel audio content. The embodiments disclosed herein are mainly described from the viewpoint of creating an automatic media remix or a mash-up from video and audio content of source videos, but the embodiments are not limited to video and audio content of source videos, but they can be applied generally to any type of media content.

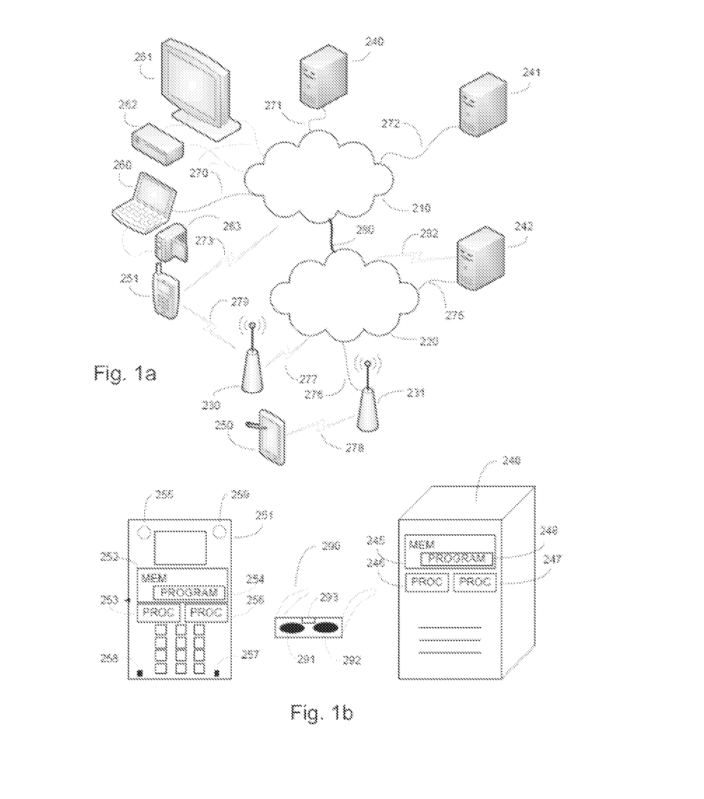

FIGS. 1a and 1b show a system and devices suitable to be used in an automatic media remixing service according to an embodiment. In FIG. 1a, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1a are shown servers 240, 241 and 242, each connected to the mobile network 220, which servers may be arranged to operate as computing nodes (i.e., to form a cluster of computing nodes or a so-called server farm) for the automatic media remixing service. Some of the above devices, for example the computers 240, 241, 242 may be such that they are arranged to make up a connection to the Internet with the communication elements residing in the fixed network 210.

There are also a number of end-user devices such as mobile phones and smart phones 251, Internet access devices (Internet tablets) 250, personal computers 260 of various sizes and formats, televisions and other viewing devices 261, video decoders and players 262, as well as video cameras 263 and other encoders. These devices 250, 251, 260, 261, 262 and 263 can also be made of multiple parts. The various devices may be connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 1b shows devices for automatic media remixing according to an example embodiment. As shown in FIG. 1b, the server 240 contains memory 245, one or more processors 246, 247, and computer program code 248 residing in the memory 245 for implementing, for example, automatic media remixing. The different servers 241, 242, 290 may contain at least these elements for employing functionality relevant to each server.

Similarly, the end-user device 251 contains memory 252, at least one processor 253 and 256, and computer program code 254 residing in the memory 252 for implementing, for example, gesture recognition. The end-user device may also have one or more cameras 255 and 259 for capturing image data, stereo video, 3D video or alike. The end-user device may also contain one, two or more microphones 257 and 258 for capturing sound. The end-user device may also contain sensors for generating the depth information using any suitable technology. The different end-user devices 250, 260 may contain at least these same elements for employing functionality relevant to each device. In another embodiment of this invention, the depth maps (i.e., depth information regarding the distance from the scene to a plane defined by the camera) obtained by interpreting video recordings from the stereo (or multiple) cameras may be utilized in the media remixing system. The end-user device may also have a time-of-flight camera, whereby the depth map may be obtained from a time-of-flight camera or from a combination of stereo (or multiple) view depth map and a time-of-flight camera. The end-user device may generate depth map for the captured content using any available and suitable mechanism

The end user devices may also comprise a screen for viewing single-view, stereoscopic (2-view), or multiview (more-than-2-view) images. The end-user devices may also be connected to video glasses 290, e.g., by means of a communication block 293 able to receive and/or transmit information. The glasses may contain separate eye elements 291 and 292 for the left and right eye. These eye elements may either show a picture for viewing, or they may comprise a shutter functionality e.g., to block every other picture in an alternating manner to provide the two views of three-dimensional picture to the eyes, or they may comprise an orthogonal polarization filter (compared to each other), which, when connected to similar polarization realized on the screen, provide the separate views to the eyes. Other arrangements for video glasses may also be used to provide stereoscopic viewing capability. Stereoscopic or multiview screens may also be autostereoscopic, i.e., the screen may comprise or may be overlaid by an optics arrangement, which results into a different view being perceived by each eye. Single-view, stereoscopic, and multiview screens may also be operationally connected to viewer tracking such a manner that the displayed views depend on viewer's position, distance, and/or direction of gaze relative to the screen.

It needs to be understood that different embodiments allow different parts to be carried out in different elements. For example, parallelized processes of the automatic media remixing may be carried out in one or more processing devices; i.e., entirely in one user device like 250, 251 or 260, or in one server device 240, 241, 242 or 290, or across multiple user devices 250, 251, 260 or across multiple network devices 240, 241, 242, 290, or across both user devices 250, 251, 260 and network devices 240, 241, 242, 290. The elements of the automatic media remixing process may be implemented as a software component residing on one device or distributed across several devices, as mentioned above, for example so that the devices form a so-called cloud.

One or more of the computers disclosed in FIG. 1a may be configured to operate a multimedia content remix service, which can be referred to as a media remix service. The media remix service is a service infrastructure that is capable of receiving user communication requests for inviting other users. The media remix service, together with the computer(s) running the service, further comprise networking capability to receive and process media content and corresponding context data from other data processing devices, such as servers operating social media portals (SMP). Herein, the term social media portal (SMP) refers to any commonly available portal that is used for storing and sharing user generated content (UGC). The UGC media content can be stored in various formats, for example, using the formats described in the Moving Picture Experts Group MPEG-4 standard. The context data may be stored in suitable fields in the media data container file formats, or in separate files with database entries or link files associating the media files and their timestamps with sensor information and their timestamps. Some examples of popular SMPs are YouTube, Flickr®, and Picasa™. It is apparent for a skilled person that the media remix service and the social media portals SMP are implemented as network domains or multimedia content databases, wherein the operation may be distributed among a plurality of servers.

A media remix can be created according to the preferences of a user. The source content refers to all types of media that is captured by users, wherein the source content may involve any associated context data. For example, videos, images, audio captured by users may be provided with context data, such as information from various sensors, such as from a compass, an accelerometer, a gyroscope, or information indicating location, altitude, temperature, illumination, pressure, etc. A particular sub-type of source content is a source video, which refers to videos captured by the user, possibly provided with the above-mentioned context information.

A user can request the media remix service an automatically created media remix version from the material available for the service about an event, such as a concert. The service may be available to any user or it may be limited to registered users only. It is also possible to create a media remix version from private video material only. The service creates an automatic cut of the video clips of the users. The service may analyze the sensory data to determine which are interesting points at each point in time during the event, and then makes switches between different source media in the final cut. Audio alignment is used to find a common timeline for all the source videos, and, for example, dedicated sensor data (accelerometer, compass) analysis algorithms are used to detect when several users are pointing to the same location on the stage, most likely indicating an interesting event. Furthermore, music content analysis (beats, downbeats), is used to find a temporal grid of potential cut points in the event sound track.

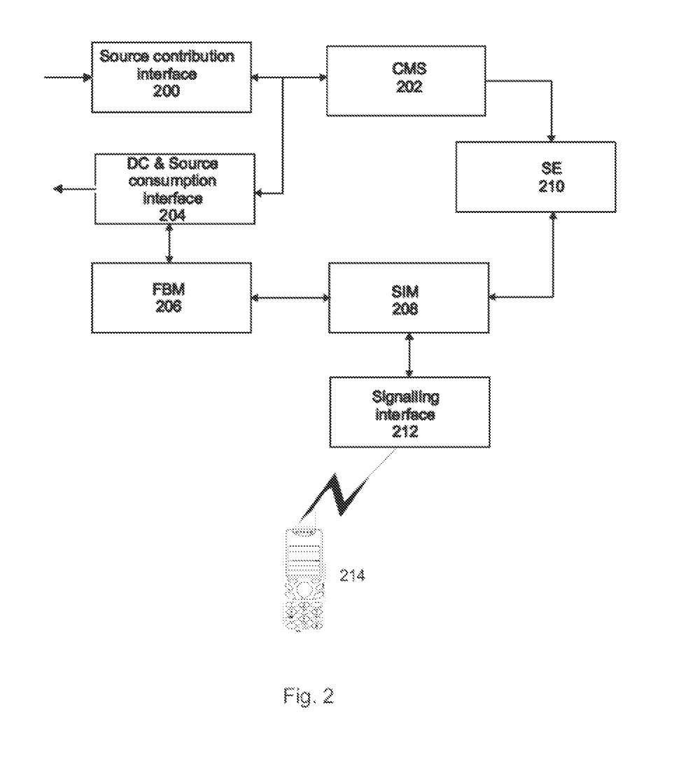

FIG. 2 shows exemplified service architecture for creating an automatically created media remix. The service architecture may include components, known as such from contemporary video editing services, for example an interface 200 for the users contributing their recorded content from the event, which interface may annotate the contributed content for clustering the content related to the same event for generating the media remix, a content management system (CMS; 202) to store/tag/organize the content, and an interface 204 for delivering the media remix and its related source content to the users to consume.

The service architecture of FIG. 2 may further comprise a feedback module (FBM; 206) to capture the content consumption feedback about the content contributed by the users and the media remix versions that have been generated. The feedback information may be provided to a synergistic intelligence module (SIM; 208), which contains the required intelligence or the logic required to analyze and create the information about the user contributed source content that is contributed to the service. The SIM is connected to a user apparatus 214 via a signaling interface 212, which enables the user to request a media remix to be created according to user-defined parameters and also to provide new UGC content to be used in the media remix generation process.

In the analysis the SIM may utilize, in addition to the feedback information, also information about the arrival distribution pattern of the source content. The SIM may use the UGC contribution data from past events in various locations and use it to generate a probabilistic model to predict user content contribution's arrival time (or upload time) to the service. The information provided by the SIM are received in a synergizing engine (SE; 210), which may be implemented as a separate module that interacts with the CMS, the SIM and the FBM to generate the media remix versions that match the criteria signaled by the user requesting a media remix. The information provided by the SIM enables the SE to utilize the previous media remix versions and their consumption feedback as inputs, in addition to the newly provided source content and its consumption feedback, wherein the SE changes the weights of different parameters which are used to combine the multitude of content.

A problem with creating the media remix relates to finding the relevant source media content. The user requesting the media remix service to create the desired media remix version must typically first search the relevant media content from a plurality of sources, such as SMPs like YouTube, Flickr®, Picasa™, Dailymotion, and Google+, and then manually preview the plurality of seemingly relevant media content to verify that they are relevant for the desired media remix version. This obviously means laborious effort for the user to search and preview the content from the plurality of suggested media content items. The more number of source media items the user wants to find, the more is the effort.

Now in order to reduce the effort needed by a user to find the relevant source media content, a new method is now presented for requesting a media remix that utilises a plurality of media items, but the user needs to indicate only a single base (or “seed”) media item for initiating the generating of the media remix.

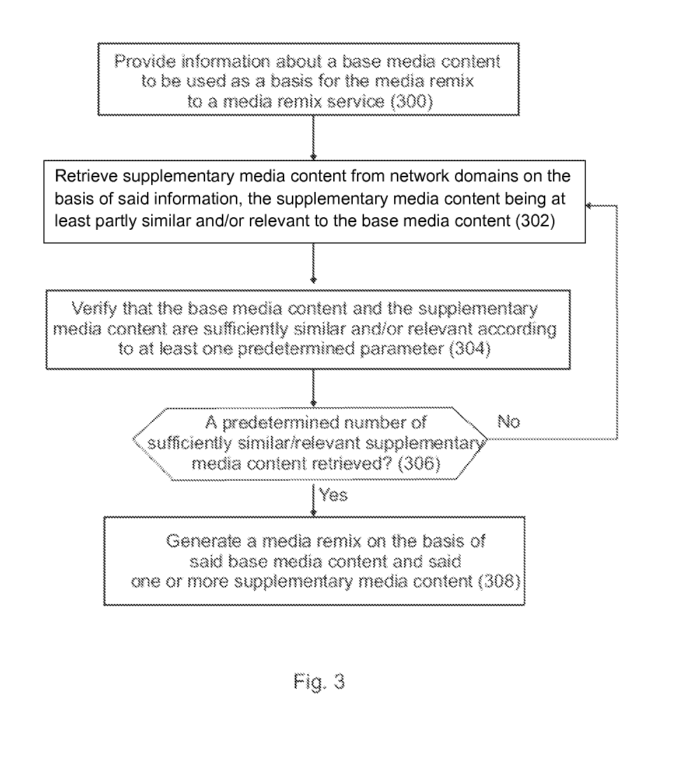

In a method according an aspect of the invention for selecting content for a media remix, which is illustrated in the flow chart of FIG. 3, information about a base media content to be used as a basis for the media remix is obtained (300) by a media remix service. The media remix service retrieves (302) one or more supplementary media content from one or more network domains or multimedia content databases on the basis of said information, said supplementary media content being at least partly similar and/or relevant to the base media content. According to an optional embodiment, for each of the retrieved supplementary media content, it is verified (304) that said base media content and said one or more supplementary media content are sufficiently similar and/or relevant according to at least one predetermined parameter. When a predetermined number of sufficiently similar and/or relevant supplementary media content has been retrieved, a media remix is generated (306) on the basis of said base media content and said one or more supplementary media content.

In other words, the user needs only to indicate a seed media as the basis for initiating the remix creation, and the media remix service automatically retrieves sufficiently similar and/or relevant media items, for example from a content storage entity or a social media portal. Thus, by retrieving potentially relevant media items from the SMPs, an extensive exposure of material is achieved in the media remix service, but still with only reasonable efforts.

According to an embodiment, information about said one or more supplementary media content from said one or more network domains or multimedia content databases is first searched on the basis of said information about the base media content. The search results, i.e. the one or more supplementary media content are then arranged in a priority order on the basis of similarity and/or relevance with metadata of said base media content. Subsequently, said one or more supplementary media content are retrieved from said one or more network domains or multimedia content databases in said priority order.

According to an embodiment, the at least one parameter for verifying sufficient similarity and/or relevance indicates that the base media content and the supplementary media content have been captured from the same audio scene. Thus, if the media remix service finds supplementary media content, which has been captured in the same event as the base media content, the audio scene parameters of said supplementary media content and said base media content are at least partly similar to each other.

According to an embodiment, the at least one parameter for verifying sufficient similarity and/or relevance indicates that the base media content and the supplementary media content use the same audio track. Herein, the media remix service may search for supplementary media content, where for example the same music track has been used as background music as in the base media content.

According to an embodiment, if the base media content and the supplementary media content have been captured from the same audio scene or use the same audio track, an audio scene matching process and audio alignment is carried out for said media contents in order to verify the sufficient similarity and/or relevance.

According to an embodiment, the at least one parameter for verifying sufficient similarity and/or relevance indicates that the base media content and the supplementary media content include a common object of interest. Thus, instead of or in addition to comparing the audio similarity of the base and supplementary media contents, objects appearing on the video/image data of the media contents may be compared. If the video/image data of the base and supplementary media contents both comprise, for example, an image of a particular person or a building, the supplementary media content may be considered to be sufficiently similar and/or relevant to the base media content.

According to an embodiment, the at least one parameter for verifying sufficient similarity and/or relevance indicates that the base media content and the supplementary media content are corresponding to the same event. For example, the GPS or any other location technology may be used to determine the co-location of the events of the base media content and the supplementary media content.

According to an embodiment, the at least one parameter for verifying sufficient similarity and/or relevance indicates that the base media content and the supplementary media content complement semantic information. For example, the semantic information in the base media content and the supplementary media content may be non-overlapping, but using them in the same remix may improve the remix quality.

According to an embodiment, the at least one parameter for verifying sufficient similarity and/or relevance indicates that the base media content and the supplementary media content have at least partly similar video content or similar video content properties in at least one view. In case of 3D or multi-view video, the similarities may be searched from the multiple views.

According to an embodiment, the at least one parameter for verifying sufficient similarity and/or relevance indicates that the base media content and the supplementary media content have been captured within a predetermined time interval. Again, instead of or in addition to comparing the audio and/or image data similarities of the base and supplementary media contents, the capturing time of the supplementary media content may be decisive. Especially, if it is determined that the supplementary media content should be searched for from the user's own content storage entity or a social media portal, the time interval criteria may provide relevant media content for the media remix. The time interval may be determined in a variety of ways, for example “within the last two weeks”, “year 2012”, “before marriage”, etc.

According to an embodiment, the at least one parameter for verifying sufficient similarity and/or relevance indicates that the base media content and the supplementary media content have a predetermined set of connections within a social media portal. Herein, the social networks of the user may provide a basis for searching the supplementary media content, whereby further definitions may be included in the search. For example, only media content from friends from a certain region or from friends that had accepted an invitation to a certain event may be search for.

According to an embodiment, the user signals said information about the base media content to the media remix service, and the information may comprise one or more of the following: a URI of the base media content, metadata about the base media content, a media file comprising the base media content. Thus, the user provides the media remix service with either information for retrieving the base media content from a network domain or the actual base media content as such.

A further problem relates to the fact that there may be available a huge amount of source media content that is sufficiently similar and/or relevant to the base media content as well as relevant for creating the desired media remix. Nevertheless, the media remix service may not be capable of determining when the media remix has reached a sufficient quality level, or if further supplementary media content should be used for enhancing the quality of the media remix. This impedes significantly to manage the load on a service implementation.

According to an embodiment, said predetermined number of sufficiently similar and/or relevant supplementary media content may be determined as a threshold for a completeness parameter, wherein said completeness parameter indicates a status of available supplementary media content.

According to an embodiment, the completeness parameter may be derived using one or more of the following parameters:
Verification match level; i.e., the number of supplementary media content verified to match the base media content;
Number of non-match retrievals; i.e., the number of retrieved supplementary media content verified not to match the base media content;
User preferences for the remix; i.e., one or more user-defined parameters for the remix;
Media information, such as duration, quality, semantic characteristics if available, etc.;
Content variety information, such as source of content, difference in content based on dominant color, number of faces, view angle, etc.

According to an embodiment, the completeness parameter has a value as a number which is derived using one or more of the parameters described above.

According to an embodiment, the completeness parameter may have a value in the range of 0 to 1. The value of 1 for the completeness parameter indicates that all the necessary content is available, whereas the value of 0 indicates that no content is available. The embodiment is not limited to the range of 0 to 1, but the range can be of any numbers so that the completeness parameter has a value in that range.

In practical implementation, depending on the desired content of the media remix and the load of the media remix service, searching and verifying the supplementary media to the extent that all the necessary content is available may take a long time. Therefore, according to an embodiment, the completeness parameter value of less than 1 may be used as a threshold, in a case where the completeness parameter value of 1 is not reachable within a certain period. A rule may be defined for generating the remix if the completeness parameter value is greater than a certain threshold until a certain waiting time: if the completeness parameter value reaches a threshold value of X1 (0<X1<1) within a first time interval T1, generating the media remix may be initiated.

According to an embodiment, further rules may be defined for threshold values of the completeness parameter that are changing over time. For example, if the completeness parameter value reaches a threshold value of X2 (0<X2<X1<1) within a second time interval T2 (T2>T1), generating the media remix may be initiated.

The rules may be defined by the user, a media remix client application residing on a user equipment or the server of the media remix service.

If none of the defined threshold values of the completeness parameter is reached within a defined time interval, the server may decide to abort or create the media remix based on available content. This may depend on the user preference for the remix and the implementation of the media remix service.

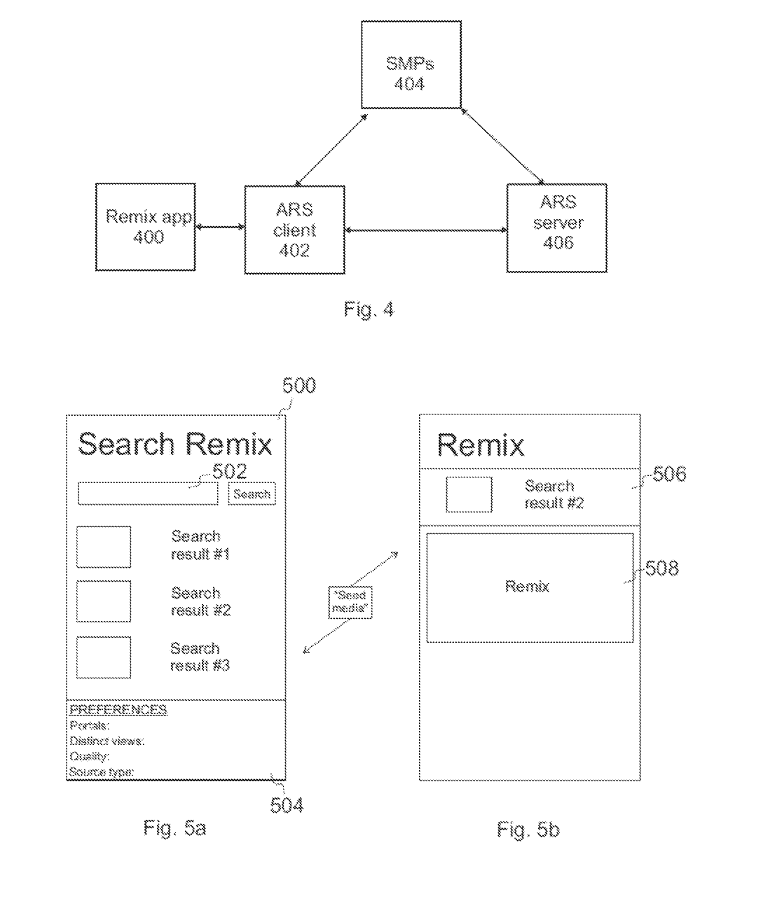

FIG. 4 depicts an overview of the media remix system according to an embodiment. The media remix system may be referred to as an asymmetric remix service (ARS) system, referring to the feature that the user only provides the base media content and the media remix service automatically searches the relevant supplementary media content.

In this embodiment, the user accesses the ARS system via a remixing application. In FIG. 4, a remixing application 400 interacts with an ARS client 402. The remixing application and the ARS client may reside on the same apparatus, such as any of the end-user devices shown in FIG. 1a, or they may be distributed on different apparatuses. The ARS client 402 interfaces with the social media portals (SMPs) 404 and an ARS server 406. On the basis of user requests for searching media, the ARS client 402 sends the requests to the SMPs 404 and delivers the search results to the remixing application 400. The user decides to use a particular media item as a base media content for the media remix, and the ARS client 402 sends the base media information and information about the other search results to the ARS server 406 for remix creation. The ARS server 406 analyses the base media information and starts to retrieve the supplementary media from the SMPs 404. The relevance verification is performed for each of the retrieved similar and/or relevant media items. The process of finding and retrieving similar and/or relevant media continues until a sufficient level of completeness parameter value has been reached. Subsequently, a media remix is created by the ARS server 406, and this is informed the ARS client 402.

It is apparent for a skilled person that even though the ARS server and the social media portals SMP 404 are illustrated as single operators in FIG. 4, they may be implemented as network domains or multimedia content databases, wherein the operation may be distributed among a plurality of servers.

FIGS. 5a and 5b show an example of a user interface (UI) 500 of the remixing application. FIGS. 5a and 5b disclose the user apparatus as a portable device 500 provided with a large, preferably touch-sensitive display 502. However, as becomes evident from what has been disclosed above, the user apparatus may also be, for example, a laptop computer, a desktop computer or any other data processing device capable of requesting a remix to be generated. Therefore, this example is not limited to portable devices or touch-sensitive displays only. For entering the user requests for searching media, the user may choose to type in certain key words in the “search” field 502. Optionally, the user may also give preferences for the search in “preference” field 504, such as to indicate the social networks that he/she wishes to leverage for searching the media he/she is interested in. In FIG. 5a, the UI shows the applicable results based on key word search: search results #1, #2 and #3. The user can preview the different media items in the search list and choose a single media as the “seed media”. In FIG. 5a, the user selects the search result #2 as the base (“seed”) media. The base media is delivered to the asymmetric remix creation system, which is indicated in FIG. 5b by showing the base media on top 506 of the UI. When the media remix has been created by the ARS server, it is delivered to ARS client and shown in the field 508.

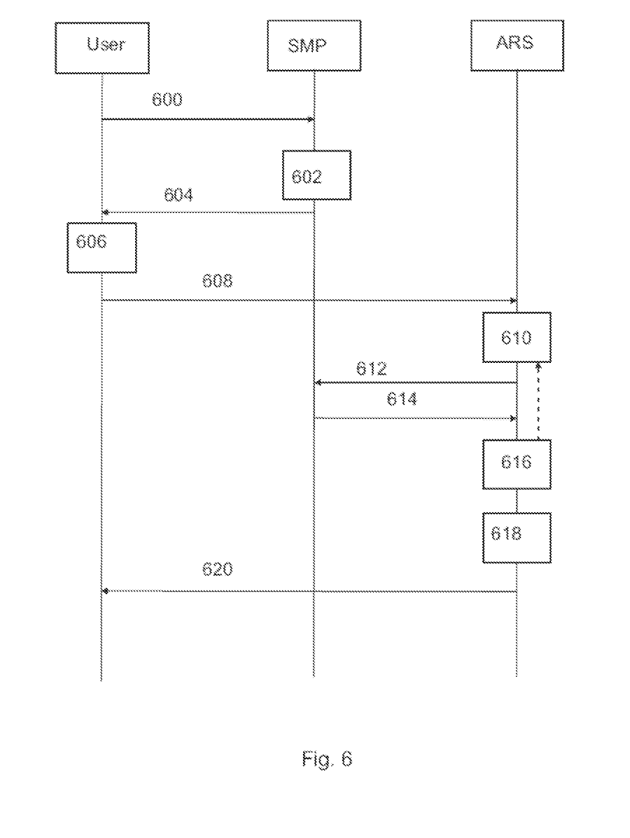

The operation of the asymmetric remix service according to an embodiment is now described in further detail by referring to an example disclosed in a signaling chart of FIG. 6. For the sake of simplifying the illustration, the operations of the remixing application and the ARS client are combined as a single operator “User”.

As described above, the user sends (600) requests for searching his/her media of interest from different SMPs. Based on the search request parameters, URLs of possible media items are searched (602) in the SMPs. Herein, various filtering options like date/time of media upload, location of the upload, media metadata (such as resolution of the video, audio format, etc.) may be used to define the search more specifically. The search results are then sent (604) to the user equipment.

The user may preview the search result and select (606) the base (“seed”) media content for the media remix creation, whereafter information about the base media content is sent (608) to the ARS server. The information may comprise the URL and metadata of the base media content or the base media content as such, for example in a file format. Together with the information, the URLs and metadata of the other search results and possible remix preferences defined by the user may be sent to the ARS server.

Based on the received information, the ARS server defines (610) search criteria for searching supplementary media content similar and/or relevant to the base media content. Herein, the ARS server may utilise the other search results provided by the ARS client and prioritize the search results based on the user preferences in order to maximize the relevance verification match for reaching a completeness parameter value of 1. The ARS server starts to request (612) supplementary media content from the SMPs, wherein the priority list of the search results may be utilised, and the ARS server then receives (614) a first supplementary media content from the SMP. The relevance verification is performed (616) on the first supplementary media content based on the remix preferences, and if positive, the first supplementary media content is added to the input list for generating the remix. The relevance verification step also includes calculation of the completeness parameter value, since the value determines whether more similar and/or relevant media items should be retrieved or the creation of the media remix should be started.

The steps 612-616 are repeated until the completeness parameter value and the threshold defined thereto indicate that a sufficient number of relevant supplementary media content has been found for the creation of the media remix. Then an automatic remix generation from the verified input media is initiated (618). Finally, the ARS server indicates (620) the availability of the requested media remix to the user.

According to another embodiment, instead of searching the base media content from the network, the user may define that media content stored on user's own data storage is used as the base media content. The data storage may be, for example, the memory of the user apparatus, and the user may use, for example, a media gallery application or any other application suitable for browsing the media content of the memory.

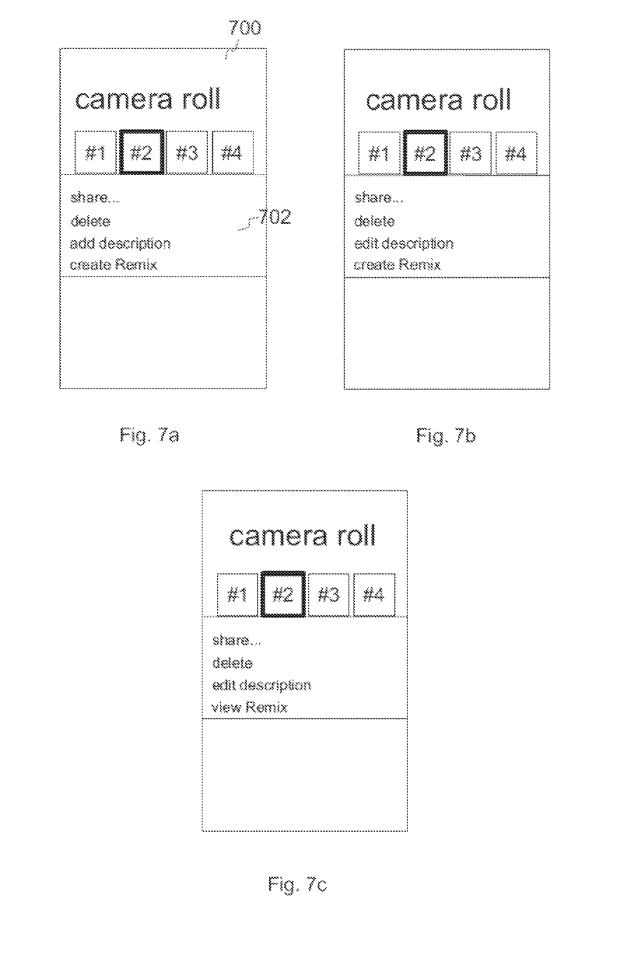

FIGS. 7a, 7b and 7c show an example of a user interface (UI) 700 of using a media gallery application for initiating and viewing the media remix. In FIG. 7a, the user is browsing the media gallery application, where four media items (#1, #2, #3, #4) are shown. The user has selected the media item #2 as the base media, for example by touching or clicking the icon of the media item #2, whereupon a menu 702 is opened on the display. It may be mandatory to add a description for the remix to be created, and the user may include keywords and/or free text description about the requested remix. On the other hand, the icon image of the media item or any other image with its metadata may act as a seed for the base media without any other additional description from the user. The “create remix” command may be enabled only when the description has been added, as shown in FIG. 7b. The user may then initiate the creation of the media remix, or edit further the description. The request for creating the media remix is sent to the ARS server, and once remix is ready, the ARS server indicates it to the ARS client. This may then be shown on the media gallery application, for example by highlighting the icon of the media item #2, and opening a menu with an option “view remix”, as shown in FIG. 7c. In other words, the ARS client operates as a background agent collecting the necessary information for the media remix in background and the remix creation is performed without any foreground indication.

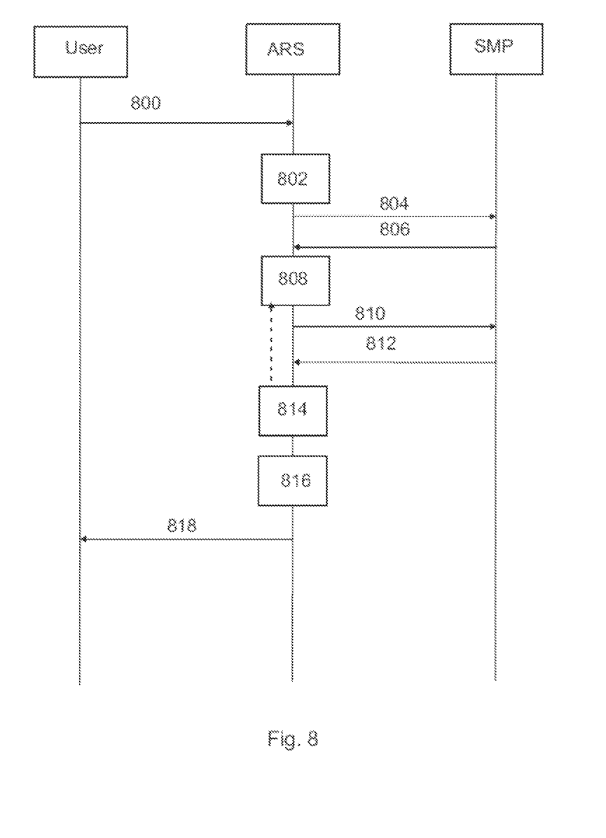

The operation of the asymmetric remix service according to the embodiment, where the media gallery application is used for initiating the media remix, is now described in further detail by referring to an example disclosed in a signaling chart of FIG. 8. Again, the operations of the media gallery application and the ARS client are combined as a single operator “User”.

The user selects the base (“seed”) media content for the media remix creation from his/her own data storage using the media gallery application, and the ARS client sends (800) information about the base media content to the ARS server. The information may comprise the URL and metadata of the base media content or the base media content as such, for example in a file format. Now, instead of the ARS client, the ARS server is responsible for searching the supplementary media content sufficiently similar and/or relevant to the base media content. Based on the base media information, the ARS server defines (802) search criteria, where filtering options like date/time of media upload, location of the upload, and media metadata may be used to define the search more specifically.

The ARS server carries out (804) the search in the SMPs, and receives (806) the search results. The ARS server may prioritize (808) the search results based on the user preferences in order to maximize the relevance verification match as soon as possible. The prioritized search results may be organised in a priority list.

The ARS server starts to request (810) supplementary media content from the SMPs according to the priority list, and the ARS server receives (812) first supplementary media content from the SMP. The relevance verification is performed (814) on the first supplementary media content based on the remix preferences, and if positive, the first supplementary media content is added to the input list for generating the remix. The relevance verification step also includes calculation of the completeness parameter value, since the value determines whether more sufficiently similar and/or relevant media items should be retrieved or the creation of the media remix should be started.

The steps 810-814 are repeated until the completeness parameter value and the threshold defined thereto indicate that a sufficient number of relevant supplementary media content has been found for the creation of the media remix. Then an automatic remix generation from the verified input media is initiated (816). Finally, the ARS server indicates (818) the availability of the requested media remix to the user.

A skilled person appreciates that any of the embodiments described above may be implemented as a combination with one or more of the other embodiments, unless there is explicitly or implicitly stated that certain embodiments are only alternatives to each other.

The various embodiments may provide advantages over state of the art. For example, the embodiments enable an easy remix creation from social media clouds that may contain a vast amount of inconsistently annotated content. Further, the embodiments enable to minimize the effort for the user to search/preview and select a single seed media item to be used in the automatic mashup or remixing, i.e., the actual request for creating the remix request can be made quickly. This results in savings in time for the user, thus affording better user experience for the service. Moreover, there is no need to upload content specifically for making a remix or mashup. The content uploaded on the cloud is re-used for remixing/mash-up purposes. The use of supplementary media in a prioritized manner with regard to its similarity and/or relevance with the base media content ensures maximum efficiency in retrieval and relevance matching operations, thus minimizing non-matching supplementary media retrieval and processing on the server. According to an embodiment, using the completeness parameter enables to automatically limit the processing on the server side.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, or CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. A method for selecting content for a media remix, the method comprising:
obtaining information about a base media content to be used as a basis for the media remix in a media remix service;
retrieving one or more supplementary media content from one or more network domains or multimedia content databases on the basis of said information, said supplementary media content being at least partly similar and/or relevant to the base media content; and
generating a media remix on the basis of said base media content and said one or more supplementary media content.

2. A method according to claim 1, the method further comprising
verifying that said base media content and said one or more supplementary media content are sufficiently similar and/or relevant according to at least one predetermined parameter; and
in response to retrieving a predetermined number of sufficiently similar and/or relevant supplementary media content, generating the media remix on the basis of said base media content and said one or more supplementary media content

3. A method according to claim 1, the method further comprising
searching information about said one or more supplementary media content from said one or more network domains or multimedia content databases on the basis of said information about the base media content;
arranging the one or more supplementary media content in a priority order on the basis of metadata of said base media content; and
retrieving said one or more supplementary media content from said one or more network domains or multimedia content databases in said priority order.

4. A method according to claim 1, wherein the at least one parameter for verifying sufficient similarity and/or relevance indicates at least one of the following:
the base media content and the supplementary media content have been captured from the same audio scene;
the base media content and the supplementary media content use the same audio track;
the base media content and the supplementary media content include a common object of interest;
the base media content and the supplementary media content are corresponding to the same event;
the base media content and the supplementary media content complement semantic information;
the base media content and the supplementary media content have at least partly similar video content or similar video content properties in at least one view;
the base media content and the supplementary media content have been captured within a predetermined time interval;
the base media content and the supplementary media content have a predetermined set of connections within a social media portal.

5. A method according to claim 1, the method further comprising
signaling said information about the base media content to the media remix service, the information comprising one or more of the following: a URI of the base media content, metadata about the base media content, a media file comprising the base media content.

6. A method according to claim 1, the method further comprising
determining said predetermined number of sufficiently similar and/or relevant supplementary media content as a threshold for a completeness parameter, wherein said completeness parameter indicates a status of available supplementary media content.

7. A method according to claim 6, wherein the completeness parameter is derived using one or more of the following parameters:
the number of supplementary media content verified to match the base media content;
the number of retrieved supplementary media content verified not to match the base media content;
one or more user-defined parameters for the remix;
media information, such as duration, quality, semantic characteristics;
content variety information, such as source of content, difference in content based on dominant color, number of faces, view angle.

8. A method according to claim 7, wherein the completeness parameter has a value as a number which is derived using one or more of said parameters.

9. A method according to claim 8, wherein the completeness parameter has a value in the range of first and second values, where the second value of for the completeness parameter indicates that all the necessary content is available, and the first value indicates that no content is available; and
the completeness parameter value between the first and second value is used as a threshold for starting to generate the media remix.

10. An apparatus comprising at least one processor, memory including computer program code, the memory and the computer program code configured to, with the at least one processor, cause the apparatus to at least:
obtaining information about a base media content to be used as a basis for the media remix;
retrieving one or more supplementary media content from one or more network domains or multimedia content databases on the basis of said information, said supplementary media content being at least partly similar and/or relevant to the base media content; and
generating a media remix on the basis of said base media content and said one or more supplementary media content.

11. An apparatus according to claim 10, further comprising computer program code configured to, with the at least one processor, cause the apparatus to at least:
verifying that said base media content and said one or more supplementary media content are sufficiently similar and/or relevant according to at least one predetermined parameter; and
in response to retrieving a predetermined number of sufficiently similar and/or relevant supplementary media content, generating the media remix on the basis of said base media content and said one or more supplementary media content.

12. An apparatus according to claim 10, further comprising computer program code configured to, with the at least one processor, cause the apparatus to at least:
searching information about said one or more supplementary media content from said one or more network domains or multimedia content databases on the basis of said information about the base media content;
arranging the one or more supplementary media content in a priority order on the basis of metadata of said base media content; and
retrieving said one or more supplementary media content from said one or more network domains or multimedia content databases in said priority order.

13. An apparatus according to claim 10, wherein the at least one parameter for verifying sufficient similarity and/or relevance indicates at least one of the following:
the base media content and the supplementary media content have been captured from the same audio scene;
the base media content and the supplementary media content use the same audio track;
the base media content and the supplementary media content include a common object of interest;
the base media content and the supplementary media content are corresponding to the same event;
the base media content and the supplementary media content complement semantic information;
the base media content and the supplementary media content have at least partly similar video content or similar video content properties in at least one view;
the base media content and the supplementary media content have been captured within a predetermined time interval;
the base media content and the supplementary media content have a predetermined set of connections within a social media portal.

14. An apparatus according to claim 10, further comprising computer program code configured to, with the at least one processor, cause the apparatus to at least:
signaling said information about the base media content to the media remix service, the information comprising one or more of the following: a URI of the base media content, metadata about the base media content, a media file comprising the base media content.

15. An apparatus according to claim 10, further comprising computer program code configured to, with the at least one processor, cause the apparatus to at least:
determining said predetermined number of sufficiently similar and/or relevant supplementary media content as a threshold for a completeness parameter, wherein said completeness parameter indicates a status of available supplementary media content.

16. An apparatus according to claim 15, wherein the completeness parameter is derived using one or more of the following parameters:
the number of supplementary media content verified to match the base media content;
the number of retrieved supplementary media content verified not to match the base media content;
one or more user-defined parameters for the remix;
media information, such as duration, quality, semantic characteristics;
content variety information, such as source of content, difference in content based on dominant color, number of faces, view angle.

17. A computer program embodied on a non-transitory computer readable medium, the computer program comprising instructions causing, when executed on at least one processor, at least one apparatus to:
obtaining information about a base media content to be used as a basis for the media remix in a media remix service;
retrieving one or more supplementary media content from one or more network domains or multimedia content databases on the basis of said information, said supplementary media content being at least partly similar and/or relevant to the base media content; and
generating a media remix on the basis of said base media content and said one or more supplementary media content.
